(19) United States
(12) Patent Application Publication
(10) Pub. No.: US 2025/0353762 A1
(43) Pub. Date: Nov. 20, 2025

(54) Portable Fountain which Pumps the Hypolimnion to Spray above the Surface in a Stratified Body of Water

(71) Applicants: Mr. Cody Keith Bateman, Oakland, TN (US); Mr. Travis Anthony Bateman, Atoka, TN (US)

(72) Inventors: Cody Keith Bateman, Oakland, TN (US); Travis Anthony Bateman, Atoka, TN (US)

(73) Assignees: Cody Keith Bateman, Oakland, TN (US); Travis Anthony Bateman, Atoka, TN (US)

(21) Appl. No.: 18/667,530

(22) Filed: May 17, 2024

(51) Int. Cl. C02F 1/74; B01F 23/234; B01F 23/237; B01F 25/72; B01F 101/00; C02F 1/00; C02F 103/00; E02B 1/00

(52) U.S. Cl. CPC C02F 1/74; B01F 23/234; B01F 23/237611; B01F 25/72; C02F 1/004; E02B 1/003; B01F 2101/305; C02F 2103/007; C02F 2201/009

(57) ABSTRACT

This invention is a portable fountain which pumps the hypolimnion to spray above the surface in a stratified body of water fountain resulting in aeration and heat transfer by accessing sub-thermocline depths. There are prior art fountains which circulates a stratified body of water, however these are permanent installations often connected to a commercial power grid. Other, portable-type fountains are not designed to access sub-thermocline depths and do not adequately circulate the hypolimnion. Thus a need exists for a portable fountain which circulates and aerates a stratified body of water for use in areas which lack a permanent fountain system. Applications of this invention involve aeration, temperature fluctuation to cool the surface during summer, and temperature fluctuation to warm the surface during winter. Benefits of this device include comfort for swimmers in hot weather, prevention of ice formation in the winter, and overall environmental improvement due to aeration.

### PRIOR ART

CN208661522U 2019-03-29 A kind of solar fountain system

CN202194797U 2012-04-18 Solar photovoltaic water pump

CN202021912723.6U 2020-09-04 Solar fountain aeration aerator

CN204999716U 2016-01-27 Solar aeration device

CN202482145U 2012-10-10 Solar et flow aeration system

CN108178346A 2013-06-19 A kind of river depth oxygenate apparatus

CN205773663U 2016-12-07 Mobile solar energy aerator

U.S. Ser. No. 11/043,463 2005-01-25 Kasco Marine Inc Illuminated floating fountain

US20090032611A1 2009-02-05 RAMPP Co Pumping mechanism for fountain

U.S. Pat. No. 3,889,880A 1975-06-17 Rain Jet Corp Floating fountain

U.S. Pat. No. 6,435,422B1 2002-08-20 Mark Wutschik Floating fountain

U.S. Pat. No. 5,273,214A 1993-12-28 Huffstutler Randall L Portable cooling device

US20030116638A1 2003-06-26 Foster Richard S. Floating fountain devices and systems

US20110180625A1 2011-07-28 Rotondo Thomas R Portable Cooling Device

U.S. Pat. No. 2,248,386A 1941-07-08 Francis C G Richardson Fountain

US1962840A1934-06-12 Owen H Rives Portable fountain

USD939042S1 2021-12-21 Shenzhen Otter Pump Industry Co., Ltd Fountain

USD631128S1 2011-01-18 Geoglobal Partners, Llc Floating water fountain

### BACKGROUND OF THE INVENTION

This invention relates to artificial water fountains or aerators which circulate deep water or water near the bottom of a stratified body of water and spray water into the air. More particularly, this invention relates to the circulation of the denser water (hypolimnion) located below the natural thermocline(s) in a stratified body of water to the water at the surface (epilimnion). In lakes and ponds with sufficient depth when surface waters warm and become more buoyant in the spring and over the course of the summer, vertical differences in water temperature can cause the water column to stratify, or separate into distinct layers. The top layer, known as the epilimnion, consists of warmer water and is generally where photosynthesis occurs. The bottom layer, or hypolimnion, usually consists of cooler, heavier water that can become depleted of dissolved oxygen by the end of summer. The metalimnion, also known as the thermocline, is a transition zone and acts as a barrier between the epilimnion and the hypolimnion keeping them from mixing. During summer months in warmer regions, the epilimnion often becomes too warm for comfort during recreational swimming. For example, Lake Havasu in Arizona has an average temperature in June through September of over 90° F. maxing out in August at an average over 98° F. According to U.S. Masters Swimming, “According to the World Health Organization, water temperatures ranging from 78 to 86 degrees Fahrenheit are generally comfortable and safe for those engaging in moderate physical activity in a pool.” In contrast, the hypolimnion remains very cold and would be very useful for cooling off surface temperatures, but cannot be easily accessed by humans due to the depth.

During winter months, the epilimnion becomes colder than the hypolimnion and at times may reach the point of freezing. Iced-over ponds or lakes may be undesirable or unsafe. During warmer months, dissolved nutrients, such as phosphates, can flow into water and over-enrich it to the point that stimulates the disproportionate growth of unwanted aquatic plants such as harmful blue-green algae. The undesirable growth can then consume oxygen and rob fish and beneficial plants of what they need as well as produce toxins. The scientific term for the process is eutrophication. Water with no oxygen circulating through it becomes stagnant and is likely to grow unsightly algae that can cause rashes, illness and in some cases death. It also poses a risk to pets for dangers such as cyanobacteria. In addition, standing water gives mosquitoes the perfect breeding habitat. Generally, fish cannot survive in water with dangerously low oxygen levels. Shallow water bodies are especially susceptible to lower oxygen simply because there is less water in which the oxygen can be stored. Poor circulation in water can also lead to temperatures hot enough to harm native fish or aquatic life. For example, trout need cooler water to survive, and if they cannot find the right conditions, they will die. If a pond or lake has poor circulation, oxygenated water that enters at the surface cannot make it down to organisms on or near the bottom.

There are prior art fountains which aerate a stratified body of water by accessing the hypolimnion and circulating the water to spray into the air to fall back down to the epilimnion generating oxygen transfer throughout the water column. However these are permanent installations often connected to a commercial power grid and are not designed to be easily relocated by a user between uses. For the purposes of this discussion, a portable fountain will be defined as a fountain designed to be relocated by a user between uses—the method of relocation may be that it is manually carried by a user; mounts to a vehicle such as a watercraft, all-terrain vehicle, or automobile; or is towed by user or said vehicles. Other, portable-type fountains are not designed to access sub-thermocline depths and do not adequately circulate the hypolimnion. For example, Chinese Patent 201871455U showcases a portable, floating solar fountain capable of realizing water spraying through the nozzle without external power supply, and is free of operational cost or electrical supply lines. However, it is not designed to access the hypolimnion nor is it designed to circulate a sufficient amount of water to the surface to provide noticeable effects such as exerting a temperature fluctuation. There are portable, floating solar-powered aerators, such as the invention described in CN205773663U, however this apparatus oxygenates the body of water by combining air and water inside the mixing pan of the apparatus instead of circulating the hypolimnion. Thus a need exists for a portable fountain which circulates the hypolimnion to the epilimnion to spray above the surface in a stratified body of water for use in areas which lack a permanent fountain system. Applications of this invention involve aeration, temperature fluctuation to cool the surface during the summer, and temperature fluctuation to warm the surface during winter. Benefits of this device include comfort for swimmers in hot weather, prevention or melting of ice formation in the winter, and overall environmental improvement due to circulation and aeration.

Previously we performed experiments in a stratified lake to determine the flow rate needed to cool a swimmer in 90° F.+ water temperatures using a fountain in which sufficient sub-thermocline depths were accessed using a standard garden hose and a prototype of the proposed invention. The results concluded that 1,100 gallons per hour (GPH) to be a sufficient flow rate whereas 180 GPH was insufficient.

In general, all pumps are designed and rated to overcome a specified amount of head pressure. Head pressure is the measured amount of resistance to the flow. This is due to the effect of gravity and air pressure. Typically the greater vertical height the water must travel correlates to a higher head pressure thus requiring a pump with sufficient power to move the fluid. However, it is beneficial to understand, for the context of this invention, that so long as a tube is submerged in the surrounding fluid, there is near-zero head pressure until the circulating fluid reaches the surface. There are two main categories of water pumps: centrifugal pumps and positive displacement pumps. Our previous experiments showed that either type of pump can be used to successfully achieve the flow rate needed for this invention. However, the type of pump utilized affects the amount of electrical power consumed, overall size, weight, and cost of the final product. Positive displacement pumps create a vacuum to suction both air and water through the diaphragm. These typically do not need to be primed and are able to create a positive flow rate without needing to be submersed in water. However, these pumps have a limited amount of head pressure that can be overcome to produce a flow without priming. In a vane-type positive displacement pump, the mechanism relies on a tight seal between the vanes and the diaphragm wall. A vane-type pump was used successfully in prior experiments to access sub-thermocline depths and pump a sufficient flow rate to spray above the surface of the lake. The important finding in this experiment was that the system did not need to be primed or submerged in order for a sufficient flow to be achieved. In a separate experiment, we used a centrifugal pump to successfully achieve the necessary flow rate after it was submerged. Centrifugal pumps use rotating impellers to move the water within. These pumps need to be primed by filling interior channels with fluid to remove all air pockets. Some centrifugal pumps are self-priming by housing a reservoir of fluid internally which is accessed to remove air pockets. The aforementioned experimental centrifugal system was tested to be lifted above the surface of the water at an average adult male height while standing on a watercraft. The system was manually primed by being fully submerged until adequate flow was achieved. Afterwards an adequate flow was sprayed continuously above the surface of the water which had been drawn from sub-thermocline depths. The main advantages of this system was it utilized light-weight and low-cost components to achieve adequate performance with low power consumption at the proper head pressure. It is also important to note that the tube used to access sub-thermocline depths was much longer than the rated head pressure of the pump. Thus the theory was proven that minimal head pressure exists while moving water through a submerged tube. This lack of needed head pressure allows for a wide range of water-pump types or configurations to be selected for this system depending on the desired application and setting.

Concerning the power supply to the water pump in this invention, our previous experiments successfully showed that the power supply could be housed within the apparatus in the form of a battery; or external to the apparatus such as utilizing a power cable to connect to a powered watercraft; or powered by an external or integrated solar panel. The advantage of utilizing an internal battery is that the system is fully self-contained and can be used independently. The disadvantage of the internal battery is that it must be recharged periodically and may run out of energy during use. The advantage of utilizing an external apparatus is that energy consumption is not a limiting factor and recharging is not necessary. In the experiment where it was connected to a powered watercraft, the alternator was able to recharge the onboard battery when the engine was running. The disadvantage is that the system is dependent on a powered vehicle for use. The advantage of utilizing a solar panel is that system can be independent without needing to be recharged. We performed previous experiments which showed that solar panels could be used to power the system to provide an adequate flow rate for significant heat transfer. The solar panel used was outfitted with buoyant foam such that it floated on the surface of the lake along with the fountain. A stationary solar panel would also be a viable option for use. Other external power sources include portable or stationary generators. The device may also be connected to a power grid infrastructure.

### SUMMARY OF THE INVENTION

The present invention involves a water pump, a nozzle, a pump, a long, insulated hose or tube, and a power cable. The components, not necessarily the power source, must be configured such that they are portable. The system may be portable in that it can be carried by a person or mounted or connected to a vehicle. The power source may be a DC battery internal to the apparatus, a DC battery external to the apparatus, a DC battery housed within a motorized watercraft, an external portable generator, a solar panel, or a commercial power grid. The fountain is still considered portable if it can be easily relocated by a user between uses and connect to an existing permanent power source at a desired location. The hose or tube must be long enough to access sub-thermocline depths. The hose or tube may be insulated to aid to prevent temperature loss during elevation. Since the hypolimnion depth varies between lakes and geographical region, the hose or tube may be able to vary in length or be modular such that extra lengths may be added. Depending on the configuration, the pump may or may not be self-priming. The pump may be a positive displacement pump. The fountain casing may either float on the water surface, rest on a floating platform, or be placed on the shore.

The system operates by pumping deep water through the external tube and into the nozzle located at or near the surface. The head pressure is minimal or zero until the liquid surpasses the surface. This allows a high percentage of the pump's power to be used to spray the water into the air. The process generates heat transfer and oxygen transfer. The heat transfer may be from cold to hot or hot to cold depending on the season.

### BRIEF DESCRIPTION OF DRAWINGS

FIG. 1 depicts a three dimensional isometric view of the invention with an integrated suction mount.

FIG. 2 depicts an exploded view of each component with assigned numbers in the integrated suction mount configuration.

FIG. 3 depicts a three dimensional isometric view of the invention in the floating apparatus configuration.

FIG. 4 depicts an exploded view of each component with assigned numbers in the floating apparatus configuration. This design shows a power cord which connects to an external power source.

FIG. 5 depicts an exploded view of each component with assigned numbers. This design shows a battery housed inside the assembly to power the device.

FIG. 6 depicts a three dimensional isometric view of the invention with an integrated solar panel.

### DETAILED DESCRIPTION OF THE INVENTION

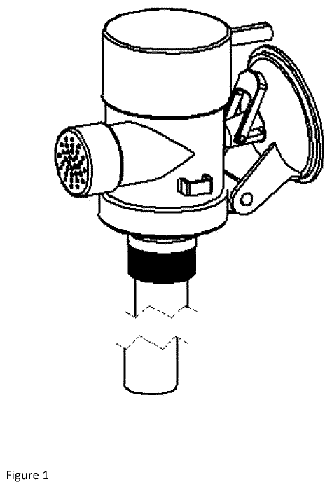

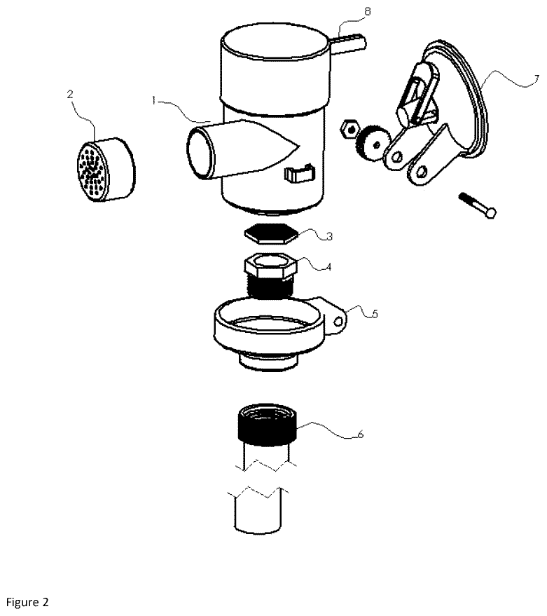

Referring to the drawings in FIG. 1 and FIG. 2, there is illustrated a pump 1 connected to a nozzle 2 which contains an array of angled thru holes such that water sprays when forced through the output valve of pump 1. A filter 3 may exist between the hose adapter 4 and input valve of pump 1. The threaded portion of the hose adapter 4 protrudes through a circular cutout on base 5 such that the hexagonal flange rests securely within the interior of the base 5. The base 5 is bonded to the outer surface of the pump 1, the bonding agent may be epoxy. An external tube 6 may be threaded onto the hose adapter 4. The suction mount 7 is bolted to the base 5 as shown. The suction mount 7 has a lever to easily induce or release suction adhesion pressure. The suction mount 7 has a knob which may be tightened or loosened in order to fixate the system in place or swivel freely. The pump 1 is wired electrically to power cable 8 and sealed to prevent water leakage into the pump encasement. If a centrifugal water pump is used in this configuration, the user will power on the device and manually submerge until proper flow is achieved. It can then be raised out of the water and suction mounted to a floating apparatus such as a watercraft. If a self-priming or positive displacement pump is used, the user will power on the device without needing to manually prime the system.

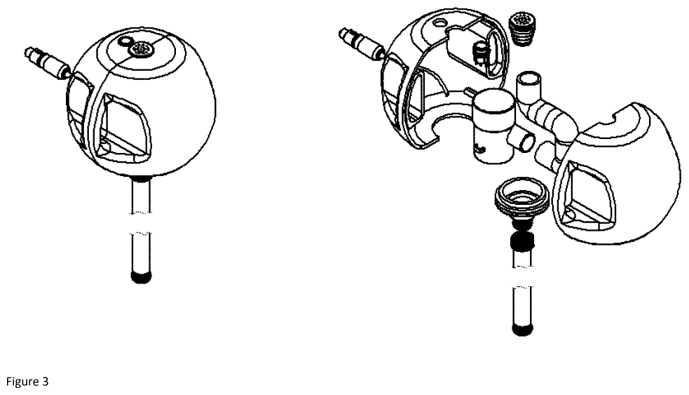

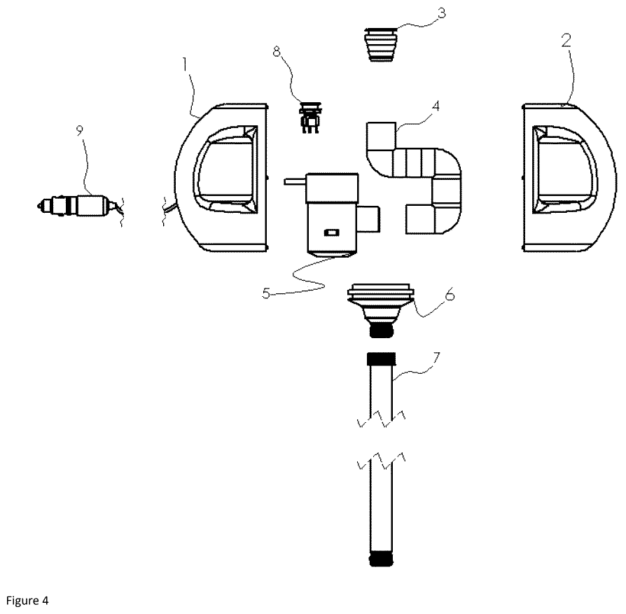

Referring to the drawings in FIG. 3 through FIG. 6, there is illustrated a casing split in to two parts: casing-left 1 and casing-right 2. The casing-left 1 contains a cavity specifically cut through the exterior such that one half of a handle is formed. This feature is mirrored on the opposite end. When the casing-left 1 is mated to the casing-right 2 a handle is formed on opposite ends of the apparatus. The formed handle from the two halves can be visualized in FIG. 3. At the top end of the casing-left 1 exists a hole sized specifically to house the on-off switch 8. The on-off switch 8 should be bonded to the casing-left 1 using a water-proof seal or adhesive. The on-off switch 8 may be further fixed to the casing-left 1 using a threaded nut as depicted in the drawings. As depicted in FIG. 3, the nozzle 3 contains angled holes on the top side placed in a circulated pattern such that water will spray when forced through the inner diameter of the nozzle 3. The inner diameter of the nozzle 3 remains as large in diameter as the wall thickness will permit so that the flow is not limited by constricting geometry. FIG. 4 illustrates the full body of the nozzle 3. Below the top side of the nozzle 3 is a recessed circular profile which exists to mate tightly with the semi-circular cutout on the top wall of the casing-left 1 and the casing-right 2 as shown in FIG. 3. The bottom end of the nozzle 3 is a barb profile which is designed to connect and seal securely to the internal tube 4. The internal tube 4 traverses to connect to the water pump 5. The internal tube 4 either may be a flexible or rigid body, the important feature is that it does not crimp along the bends so as to cut off or limit the flow of fluid. The internal tube 4 may seal to the nozzle 3 and the water pump 5 using a press-fit and/or a water-resistant adhesive. The water pump 5 must be connected and sealed to the adapter 6. On the top end of the adapter 6 exists a geometry which directly accepts the bottom end of the water pump 5. Adhesive sealant should be used at this junction to ensure water tightness. Around the exterior of the adapter 6 is a recess which accepts the circular cutout of the case-left 1 and case-right 2 as drawn in FIG. 3. The bottom end of the adapter 6 exists a male threaded member which connects to the external tube 7. The inner diameter of the adapter 6 tapers gradually from the water pump 5 to the bottom end of the adapter 6. The top end of the external tube 7 contains a female threaded member which connects to the male threaded member of the adapter 6. The bottom end of the external tube 7 has a male threaded member which may connect to an additional external tube 7 for added length.

Any number of external tubes 7 may be linked. The external tube 7 may be made out of a material with low heat conduction, such as a plastic or rubber. It may be made out of a conductive material, such as a stainless steel, and covered with insulating material such as rubber. The external tube 7 may be either flexible or rigid. The connections may be threads, as shown, or press-fits, snap-fits, clamped fits, or any combination thereof. The current design and prototypes utilize standard garden hoses for the external tube 7.

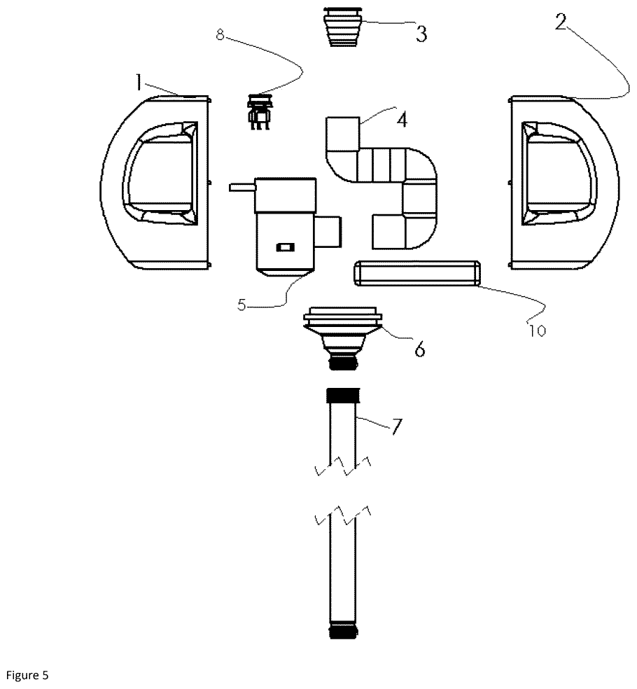

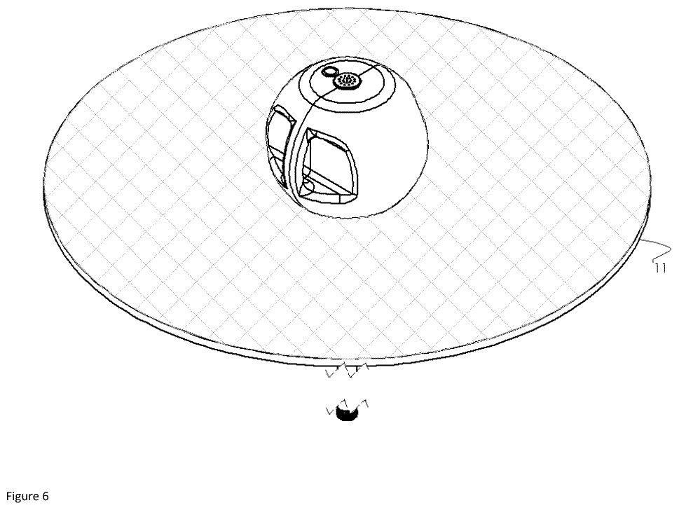

FIG. 4 shows the configuration as it connects to an external power source using the power adapter 9. Power adapter 9 is wired into the water pump 5 and on-off switch 8. The power adapter 9 traverses through a hole in the wall of the case-left 1 and sealed to prevent water from leaking into the encasement. Power adapter 9 features a plug which connects to a standard auxiliary power outlet found commonly in automobiles, personal watercrafts, all-terrain vehicles, gas powered generators, and solar panels and may be used as external power sources for this invention. The power adapter 9, on-off switch 8, and water pump 5 may also be adapted to run on alternating current as found in commercial power grids. FIG. 5. Shows the configuration as it contains an internal power source 10. The internal power source 10 may be a battery as depicted in FIG. 5 or an integrated solar panel 11 as depicted in FIG. 6. Proper assembly of the device ensures that all exterior seams are sealed to prevent water from seeping into the encasement. This prevents damage to the electrical components. This also provides buoyancy to the apparatus such that it floats on water. The weight of the exterior tube 7, especially once filled with fluid, ensures the device remains upright with the nozzle 3 directed upwards. Proper use of this device involves setting in a stratified body of water and extending the external tube 7 to the hypolimnion. Depending on the type of water pump used, it may be necessary to manually prime the system by submerging the device until all air pockets have escaped from the nozzle 3, internal tube 4, adapter 6, and external tube 7.

The device power consumption, flow output, size, shape, and weight may vary based on the desired application and setting for the device. For example, in one configuration the device is lightweight, floats on water, can be carried comfortably by a single user, and may be stored easily within vehicle compartments. In another configuration (FIG. 1 and FIG. 2) the device output is mountable to a powered vehicle such as a personal watercraft, automobile, or all-terrain vehicle. In another configuration, the device is mounted to a trailer and towed by a powered vehicle. In all three configurations the device is portable and may utilize either an internal power source or external power source as previously described.

The type of water pump 5 may be selected based on the application and configuration. For the lightweight configuration a centrifugal pump that is not self-priming may be desired as this pump-type typically produces a high flow rate with minimal losses resulting in efficient power consumption. Since the apparatus in this configuration is lightweight, a user can easily submerge the device until the pump fully engages and water flows continuously after being released to the surface. For larger and heavier configurations, a self-priming or positive displacement pump is desired for minimal effort by the user to engage adequate flow.

Determining the adequate flow rate is dependent upon the application of this device. Previous experiments showed that 1,100 gallons per hour (GPH) to be a sufficient flow rate whereas 180 GPH was insufficient to cool a swimmer in a stratified lake with a water temperature of 90°+ Fahrenheit. 1,100 GPH in a centrifugal pump was also found sufficient to raise the system out of the body of water an acceptable height with negligible reduction in flow rate. Applications to aerate a small pond may utilize a smaller system with a lower flow rate. Applications to melt ice in a large body of water may utilize a larger system with a higher flow rate.

For the purposes of the claims, a portable fountain will be defined as a fountain designed to be relocated by a user between uses—the method of relocation may be that it is manually carried by a user; mounts to a vehicle such as a watercraft, all-terrain vehicle, or automobile; or is towed by user or said vehicles. The fountain is still considered portable if it can be easily relocated by a user between uses and connect to an existing permanent power source at a desired location.

1. A portable fountain comprising:
a pump, a nozzle, an external tube long enough to access the hypolimnion of a stratified body of water, and a power cable.

2. A fountain apparatus as in claim 1, wherein said water pump is a self-priming water pump, a positive displacement pump, or a non-self-priming centrifugal pump.

3. A fountain apparatus as in claim 1, further comprising of a suction mount, a filter, a hose adapter, and a base which is utilized to connect said suction mount, said filter, said hose adapter and said external tube together.

4. A fountain apparatus as in claim 1, further comprising of a buoyant casing such that it floats independently on the surface of water.

5. A fountain apparatus as in claim 1, further comprising of a waterproof on-off switch integrated within the circuitry.

6. A fountain apparatus as in claim 1, wherein said external tube consists essentially of a material with low heat conductivity.

7. A fountain apparatus as in claim 6, wherein said external tube is flexible.

8. A fountain apparatus as in claim 6, wherein said external tube is rigid and may further comprise of multiple pieces which can be coupled together.

9. A portable fountain as in claim 1 further comprising of an integrated power source.

10. A fountain apparatus as in claim 9 in which the integrated power source is a battery.

11. A fountain apparatus as in claim 9 in which the integrated power source is a solar panel.

12. A fountain apparatus as in claim 9 in which the integrated power source is a gas generator.

13. A fountain apparatus as in claim 9 in which the integrated power source is an alternator connected to a gas engine.
